(19) United States
(12) Patent Application Publication
(10) Pub. No.: US 2009/0241402 A1
(43) Pub. Date: Oct. 1, 2009

(54) Waterfowl Attracting Shotgun Shells and Method

(76) Inventor: Jerry David KRAFT, Ashville, OH (US)

Correspondence Address: BUTZER & CHEN LAW, LLC, 870 HIGH STREET, SUITE 104, WORTHINGTON, OH, 43085, US

(21) Appl. No.: 12/060,412

(22) Filed: Apr. 1, 2008

(51) Int. Cl. A01M 31/06

(52) U.S. Cl. 43/3

(57) ABSTRACT

Waterfowl attracting shotgun shells that include case, primer, powder charge, wadding, and weighted material. When the weighted material is fired into the air, the material falls back to earth. A speed of at which the weighted material falls and an appearance of the weighted material as it falls are chosen to attract waterfowl. In preferred embodiments, the speed is about a speed that a shot waterfowl falls after being shot or a live waterfowl lands, and the appearance is a fluttering appearance. Each waterfowl attracting shotgun shell can include one piece of weighted material or plural pieces. In use, one or more waterfowl attracting shotgun shells can be loaded into a shotgun along with regular shotgun shells.

### BACKGROUND OF THE INVENTION

1. Field of the Invention

This invention relates to a method of attracting waterfowl using waterfowl attracting shotgun shells, for example when hunting.

2. Description of the Related Art

Hunters use a wide variety of objects and techniques to attract waterfowl such as ducks and geese when hunting. Two of the most common are decoys and calls. However, these are not always satisfactorily effective.

### SUMMARY OF THE INVENTION

When a waterfowl is shot out of the air with a shotgun (or any other gun), the waterfowl falls to earth. A waterfowl being shot out of the air and the sound of the shotgun firing usually scares off nearby waterfowl. However, more distant waterfowl often will not be scared off. In fact, they will often actually land near where the shot waterfowl fell. One theory is that those other waterfowl instinctively land because they perceive the shot waterfowl as landing.

The invention takes advantage of this phenomenon through use of waterfowl attracting shotgun shells. The parts of a typical shotgun include case, primer, powder charge, wadding, and shot. Instead of shot, waterfowl attracting shotgun shells include weighted material that when fired into the air falls back to earth. A speed of at which the weighted material falls and an appearance of the weighted material as it falls are chosen to attract waterfowl. In preferred embodiments, the speed is about a speed that a shot waterfowl falls after being shot or a live waterfowl lands, and the appearance is a fluttering appearance.

In different embodiments, the weighted material can take various forms. Examples include but are not limited to a parachute like form, a weighted streamer like form, and a sheet like form. The weights also can take many forms and in some embodiments have a ballistic shape. The material can be colored in a great variety of ways.

Each waterfowl attracting shotgun shell can include one piece of weighted material or plural pieces.

In some embodiments, the wadding of the waterfowl attracting shotgun shell encases the weighted material at least partially through its upward flight and then opens. The can facilitate the weighted material in reaching its intended altitude before opening up and fluttering back to earth.

In use, one or more waterfowl attracting shotgun shells can be loaded into a shotgun along with regular shotgun shells. The shells preferably are loaded so that the waterfowl attracting shotgun shells are fired first, followed by the regular shotgun shells. Thus, a hunter could simply fire one or more waterfowl attracting shotgun shells into the air to attract waterfowl and immediately be ready to fire on any waterfowl attracted by those shells.

This brief summary has been provided so that the nature of the invention may be understood quickly. A more complete understanding of the invention may be obtained by reference to the following description of the preferred embodiments thereof in connection with the attached drawings.

### BRIEF DESCRIPTION OF THE DRAWINGS

FIG. 1 shows an overall design of a waterfowl attracting shotgun shell.

FIG. 2 shows use of a waterfowl attracting shotgun shell.

FIG. 3 shows an embodiment of the weighted material with a parachute like form.

FIGS. 4 and 5 show embodiments of the weighted material with streamer like forms.

FIG. 6 shows an embodiment of the weighted material with a sheet like form.

FIG. 7 shows an embodiment of a waterfowl attracting shotgun shell with one piece of weighted material.

FIG. 8 shows an embodiment of a waterfowl attracting shotgun shell with plural pieces of weighted material arranged in a stacked fashion, with the weights having a disc shape.

FIG. 9 shows an embodiment of a waterfowl attracting shotgun shell with plural pieces of weighted material in a packed arrangement, with the weights having a ballistic shape.

FIG. 10 shows an embodiment of a waterfowl attracting shotgun shell with wadding that encases the weighted material at least partially through its upward flight and then opens.

### DETAILED DESCRIPTION OF THE INVENTION

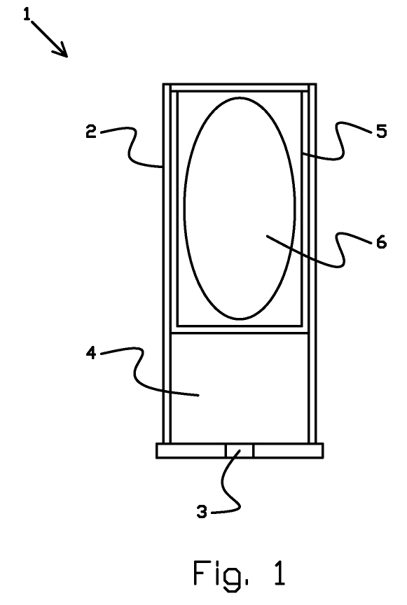

FIG. 1 shows an overall design of waterfowl attracting shotgun shell 1. The shell includes case 2, primer 3, powder charge 4, wadding 5, and one or more pieces of weighted material 6. Weighted material 6 is shown as an oval to represent various different possible forms of the material, some of which are explained in more detail below. When fired into the air, the weighted material falls back to earth at a speed and with an appearance that attracts waterfowl. The types of waterfowl that can be attracted are numerous. Examples include, but are not limited to, various types of duck and geese.

The shell in FIG. 1 is shown as a center fire shotgun shell. However, the invention is equally applicable to rim fire shotgun shells as well as any other type of shotgun shell and even larger caliber (e.g., 0.50 cal) shells for other types of firearms. (Cartridges for those other types of firearms will be considered to be shotgun shells if constructed as described herein.)

In a preferred embodiment, the weighted material comprises environmentally safe materials. For example, the weights can be made of steel, tungsten, ceramic, heavy cardboard, or other biodegradable material. The material portion can be made of cotton, paper, wool, or other biodegradable material.

The weighted material can be colored and patterned in practically any way. Examples include white on one side and black on the other, various colored patterns, and the like. In one embodiment, the material is colored and patterned using colors that match a type of waterfowl to be attracted.

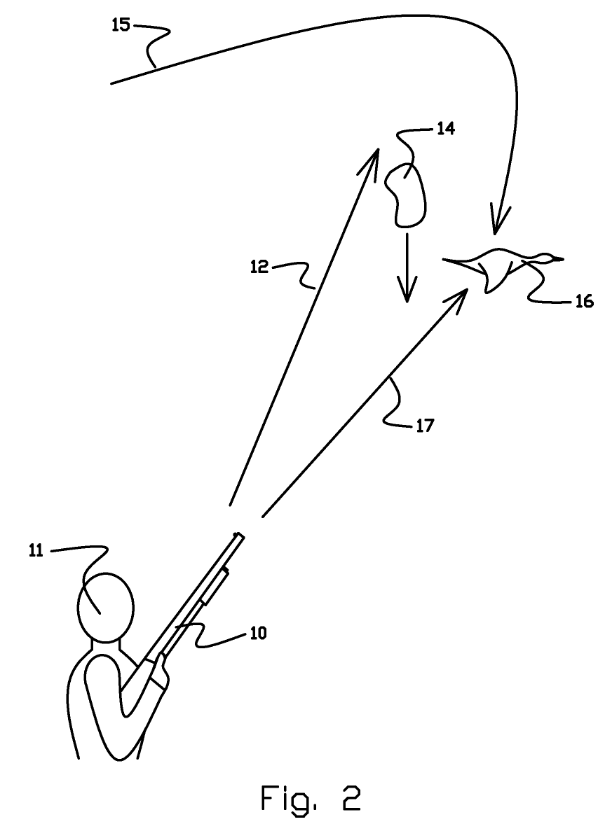

FIG. 2 shows use of a waterfowl attracting shotgun shell. In preparation of this operation, shotgun 10 is loaded with one or more waterfowl attracting shotgun shell(s) and regular shotgun shell(s). Hunter 11 fires 12 one or more waterfowl attracting shotgun shells into the air. Weighted material 14 from the waterfowl attracting shotgun shell(s) falls back to earth. In a preferred embodiment, a speed at which weighted material 14 falls is about a speed that a shot waterfowl falls after being shot or a live waterfowl lands, and the appearance of weighted material 14 as it falls is a fluttering appearance. This can attract 15 waterfowl 16 for hunter 11 to shoot 17.

The weighted material preferably reaches an altitude of 25 to 100 yards when fired into the air. The material preferably takes two to twenty seconds to fall back to earth, and more preferably takes four to ten seconds to fall back to earth. Shells with weight material that reach different altitudes and falls at different speeds also can be used.

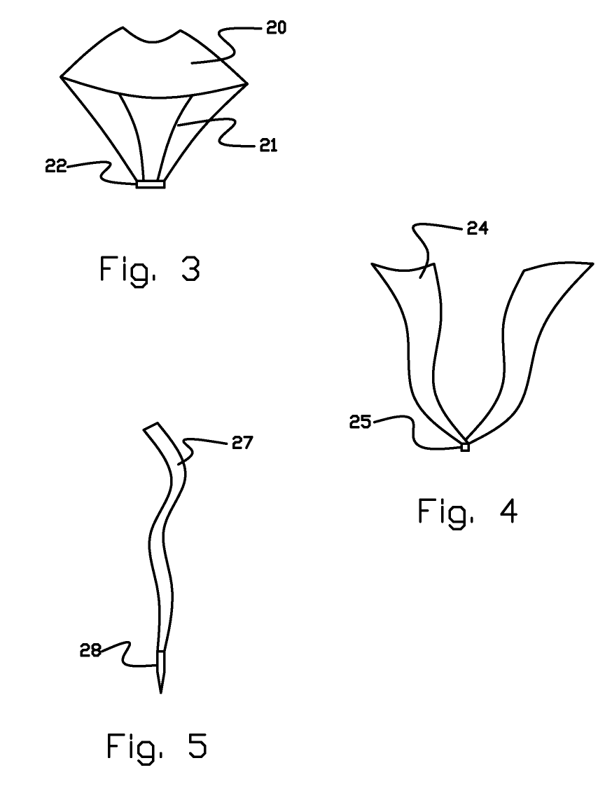

As mentioned above, the weighted material in a waterfowl attracting shotgun shell can take many forms. Some examples are shown in FIGS. 3 to 6. Other forms and shapes can be used.

FIG. 3 shows an embodiment of the weighted material with a parachute like form. This form includes material 20 shaped like a parachute attached by strings 21 to weight 22.

FIGS. 4 and 5 show embodiments of the weighted material with streamer like forms. In FIG. 4, material 24 forms two wing-shaped (i.e., tapered) streamers with weight 25 attached where the streamers join each other. In other embodiments, more streamers can be used. In FIG. 5, material 27 forms a single straight streamer with weight 28 at one end. The weight is shown as having a ballistic shape, which can help the weighted material to reach a higher altitude. Combinations of the features shown in FIGS. 4 and 5 can be used, as well as other designs.

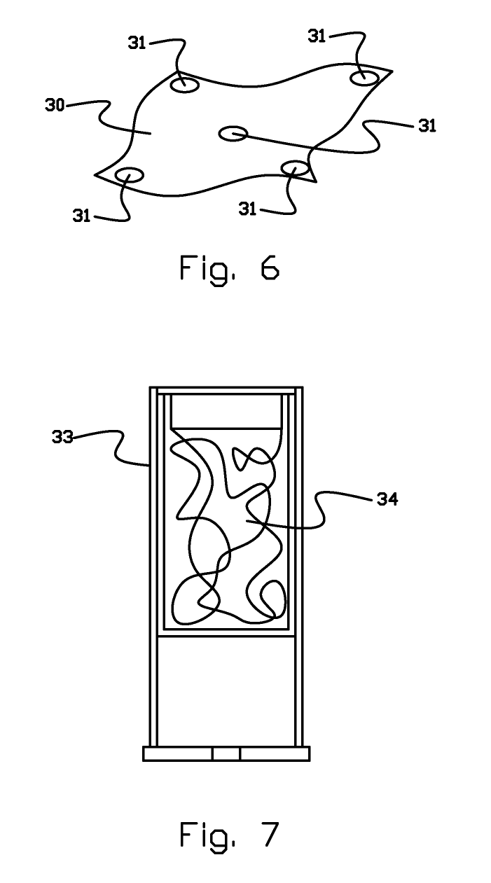

FIG. 6 shows an embodiment of the weighted material with a sheet like form. Material 30 is shown as a single square sheet. Multiple sheets and other shapes of sheets can be used. One or more weights can be placed at various locations on the sheet(s), for example at locations 31 shown in FIG. 6.

Various sized of materials can be used in these embodiments. Preferably, sizes less than one foot in any given dimension are used, although this need not be the case.

FIG. 7 shows an embodiment of a waterfowl attracting shotgun shell with one piece of weighted material. Shotgun shell 33 in FIG. 7 includes one piece of weighted material 34. This material and its weight can be of any desired form, shape, and size that will fit in the shotgun shell.

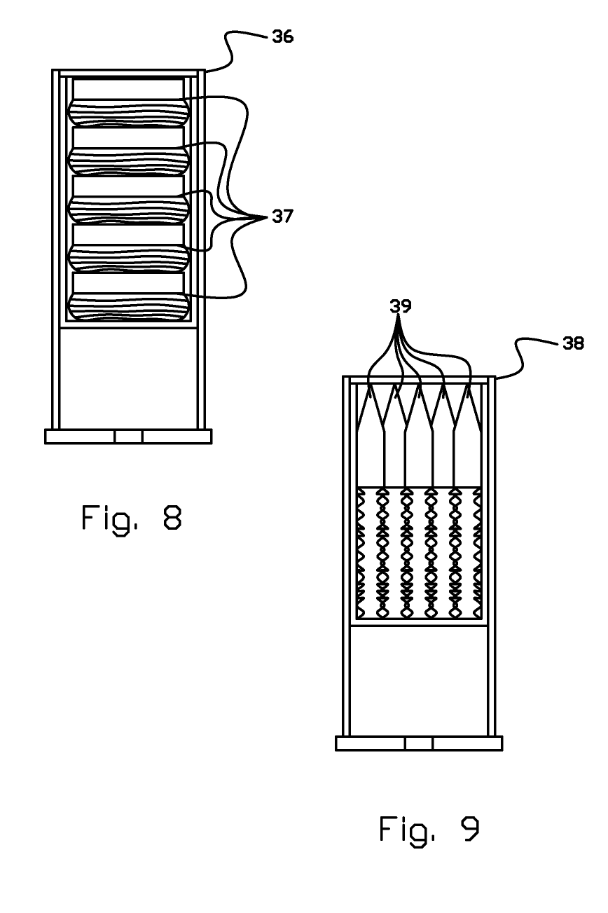

FIG. 8 shows an embodiment of a waterfowl attracting shotgun shell with plural pieces of weighted material 36 arranged in a stacked fashion, with weights 37 having a disc shape. This is just one manner in which the weighted material can be stacked in a shotgun shell.

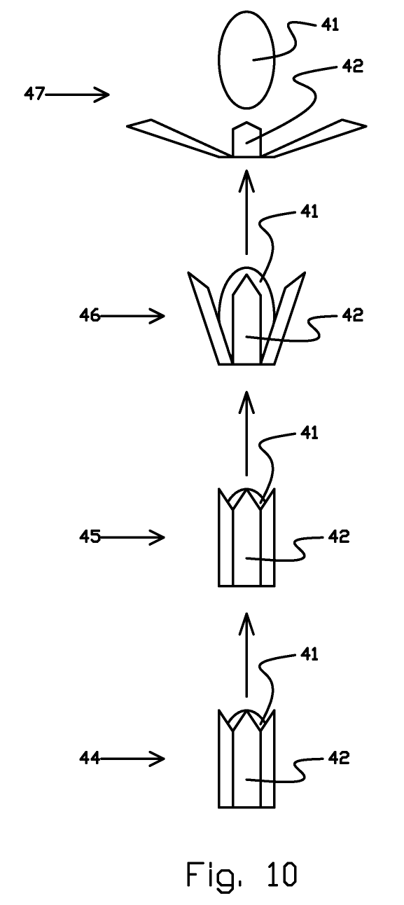

FIG. 9 shows an embodiment of a waterfowl attracting shotgun shell with plural pieces of weighted material 38 in a packed arrangement, with weights 39 having a ballistic shape. The ballistic shape of the weights can help the weighted material reach a higher altitude.

Five pieces of weighted material are shown for both of the shells depicted in FIGS. 8 and 9. Preferably, if multiple pieces of weighted material are used in a shell, two to six pieces are used. However, in other embodiments, fewer (i.e., one) or more (i.e., seven or more) pieces can be included. Again, the material and their weights can be of any desired form, shape, and size that will fit in the shotgun shell.

FIG. 10 shows an embodiment of a waterfowl attracting shotgun shell with wadding that encases the weighted material at least partially through its upward flight and then opens. In this figure, one or more pieces of weighted material are represented by oval 41, and wadding 42 of the shell is shown in various stages. At stage 44, the shell has not been fired and wadding 42 is closed. The shell has been fired at stage 45, and wadding 42 is still closed. At stage 46, wadding 42 has started to open due to air resistance during the wadding's flight. Wadding 42 has fully opened at stage 47, releasing the weighted material to fall back to earth. This arrangement can help the weighted material to reach a higher altitude.

Waterfowl attracting shotgun shells can be used with various other attractants. For example, a call using sound playing technology common to certain holiday cards can be incorporated into the weighted material. Other attractants and features also can be added.

### ALTERNATIVE EMBODIMENTS

The invention is in no way limited to the specifics of any particular embodiments and examples disclosed herein. The terms “preferably,” “preferred embodiment,” “one embodiment,” “other embodiments,” “can be,” “for example,” and the like denote features that can be included in embodiments of the invention but are not (necessarily) essential. Any of the features shown with any of the embodiments can be used with any other embodiments. Many other variations are possible which remain within the content, scope and spirit of the invention, and these variations would become clear to those skilled in the art after perusal of this application.

1. A waterfowl attracting shotgun shell, comprising:
case, primer, powder charge, wadding; and
one or more pieces of weighted material that when fired into the air fall back to earth with a fluttering appearance.

2. A waterfowl attracting shotgun shell as in claim 1, wherein the weighted material further comprise plural pieces of weighted material.

3-5. (canceled)

6. A waterfowl attracting shotgun shell as in claim 1, wherein the weighted material takes a parachute like form.

7. A waterfowl attracting shotgun shell as in claim 1, wherein each piece of the weighted material takes a streamer like form with an attached weight.

8. A waterfowl attracting shotgun shell as in claim 1, wherein the weighted material takes a sheet like form.

9. A waterfowl attracting shotgun shell as in claim 1, wherein the weighted material comprises environmentally safe materials.

10. A waterfowl attracting shotgun shell as in claim 1, wherein the wadding encases the weighted material at least partially through its upward flight after exiting a shotgun barrel and then opens to release the weighted material.

11. A method of hunting, comprising the steps of:
loading a shotgun with one or more waterfowl attracting shotgun shells and regular shotgun shells;
firing one or more of the waterfowl attracting shotgun shells into the air to attract waterfowl;
firing one or more of the regular shotgun shells at the waterfowl;
wherein each waterfowl attracting shotgun shell includes case, primer, powder charge, wadding, and one or more pieces of weighted material that when fired into the air fall back to earth at a speed and with an appearance that attracts waterfowl.

12. A method of hunting as in claim 11, wherein the speed is about a speed that a shot waterfowl falls after being shot or a live waterfowl lands, and the appearance is a fluttering appearance.

13. A method of hunting as in claim 11, wherein the weighted material reaches an altitude of 25 to 100 yards when fired into the air.

14. A method of hunting as in claim 11, wherein the weighted material takes 2 to 20 seconds to fall back to earth.

15. A method of hunting as in claim 11, wherein the weighted material takes 4 to 10 seconds to fall back to earth.

16. A method of hunting as in claim 11, wherein the weighted material takes a parachute like form.

17. A method of hunting as in claim 11, wherein the weighted material takes a streamer like form.

18. A method of hunting as in claim 11, wherein the weighted material takes a sheet like form.

19. A method of hunting as in claim 11, wherein the weighted material comprises environmentally safe materials.

20. A method of hunting as in claim 11, wherein the wadding encases the weighted material at least partially through its upward flight and then opens.
